(19) United States
(12) Patent Application Publication
(10) Pub. No.: US 2007/0116291 A1
(43) Pub. Date: May 24, 2007

(54) System and method for utilizing a proximity network system for providing wireless communication network authentication

(76) Inventors: Shmuel Silverman, Buffalo, IL (US); Thomas C. Hill, Crystal Lake, IL (US); Robert M. Johnson, Lake Zurich, IL (US); Peter J. Stanforth, Winter Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/269,958

(22) Filed: Nov. 9, 2005

(51) Int. Cl. H04K 1/00

(52) U.S. Cl. 380/270

(57) ABSTRACT

A proximity detection system (100) includes a substantially flat electronic circuit that can be printed on a label or tag (113). The tag (113) is used with an electronic device (103, 107, 109, 111) for wireless communication in a network where the tag is affixed to the electronic device for authenticating access to the network. Any number of tags (113) may be include different encryption algorithms for communicating in the network based on groups or subgroups of electronic devices.

### FIELD OF THE INVENTION

The present invention relates generally to proximity networks and more particularly to creating a network using passive printed circuit tags that provide user authentication.

### BACKGROUND

Today, many electronic devices can communicate with other devices through the use of radio frequency (RF) wireless connections such as Bluetooth or wireless fidelity (WiFi). As wireless communications become the dominant form of interconnection between electronic devices in both the home and the office, security to prevent unauthorized access to these wireless communications systems becomes of greater importance. Although most conventional communication systems include some form of security such as authentication and/or encryption, even the best security systems may be subject to being hacked or breached by unauthorized users.

One technology that has been used to provide both location tracking and security is the radio frequency identification (RFID) tag. A disadvantage in using RFID technology is that it can be complex and expensive, requiring the use of bulky cards that are affixed to the tracking object. Another type of technology called “poly apply” by the PolyApply Consortium (www.polyapply.org) is used to produce an electronic circuit on a flat surface such a paper or a polymer tape. Examples utilizing this technology include U.S. Pat. No. 6,018,299 to Eberhardt, which is herein incorporated by reference, which describes a radio frequency identification tag having a circuit chip which is coupled to an antenna and comprises a conductive pattern that is printed onto a substrate. U.S. Pat. No. 6,094,138 to Eberhardt et al., which is incorporated by reference, describes an integrated circuit assembly that includes an integrated circuit coupled to printed circuit conductors such as tag electrodes on a flexible substrate. U.S. Pat. No. 6,891,110 to Pennaz et al., which is herein incorporated by reference, describes an RFID tag that uses an integrated circuit that is easily connected to an antenna. U.S. Pat. No. 6,091,332 to Eberhardt et al., which is herein incorporated by reference, discloses a radio frequency identification tag whose integrated circuit is easily bonded to a substrate. Finally, U.S. Pat. No. 6,384,727 to Diprizio et al., which is also herein incorporated by reference, discloses a capacitively powered radio frequency identification device that uses a substrate with first and second surfaces to form the capacitor for charging the device.

Thus, those skilled in the art will recognize that the technology to produce a substantially flat RF circuit that can be energized when in proximity to an electric field is currently available for use. Since an antenna can be co-located with the circuit, these devices can be easily concealed for specialized use. A disadvantage associated with the “poly apply” technology is that it is utilized for large-scale location applications and not for providing authenticating information on smaller networks. Moreover the technology has been used as a single use application and not in tandem or multiple applications for enabling authenticated communications within groups or subgroups within a network.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 2 is a block diagram illustrating operation of an identification tag in a proximity detection system.

FIG. 3 is a diagram illustrating communications between two devices having various tags utilizing corresponding algorithms.

FIG. 4 is a diagram illustrating communications between three devices having a plurality of tags utilizing corresponding communications encryption algorithms.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a proximity network system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the proximity network described herein. The non-processor circuits may include, but are not limited to, a radio receiver, a radio transmitter, signal drivers, clock circuits, power source circuits, and user input devices. As such, these functions may be interpreted as steps of a method to perform proximity network detection. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Turning now to FIG. 1, a proximity network system 100 includes a base station transceiver 101 operating on a WiFi standard such as IEEE 802.11, 802.16 or the like. Those skilled in the art will recognize that while WiFi is used in this example, Bluetooth or wide area network standards are also possible. The network includes a plurality of devices such as a personal computer (PC) 103, a printer 105, a household appliance 107 such as a kitchen oven, range or dishwasher, an entertainment device 109 such as a digital video disc (DVD) player or gaming device, as well as other devices 111 used around the home. Each device 103-111 includes at least one tag 113 that is affixed to the device that works to personally authenticate the device, allowing it access to the home network 101. As long as the tag 113 is continually affixed to a device, the tag will continue to be energized through its proximity to the device. By way of example, the tag might be affixed directly to the personal computer 103 and an external drive 115 or other media device such as a compact disk (CD) or floppy disk (not shown). In one instance, the tag will allow the PC 103 access to the network. When affixed to the external drive 115 the tag will allow access of the external drive 115 to the PC 103 allowing it to share its data with the PC 103.

Similarly, the household appliance 107 such as a kitchen oven can be used with a digital reader 117 that includes a tag 113. In this embodiment, the tag 113 not only allows access to the home network 101 but can also verify that data such as a recipe received by the reader 117 can instruct the household appliance 107 regarding cooking temperatures and the cooking time duration for operation. It should be evident to those skilled in the art, although a recipe is used here by way of example, that any digital data can be input to the household appliance 107 through the use of a tag 113. The invention also allows an entertainment device 109 such as a DVD player to utilize a tag 113 to not only gain access to the home network 101 but also control the media used with the device. For example, a DVD media 119 can be used with a tag 113 to authenticate each DVD that can be used with the DVD player. If the tag 113 is not affixed to the DVD 119, then the DVD media cannot be used with the DVD player 109.

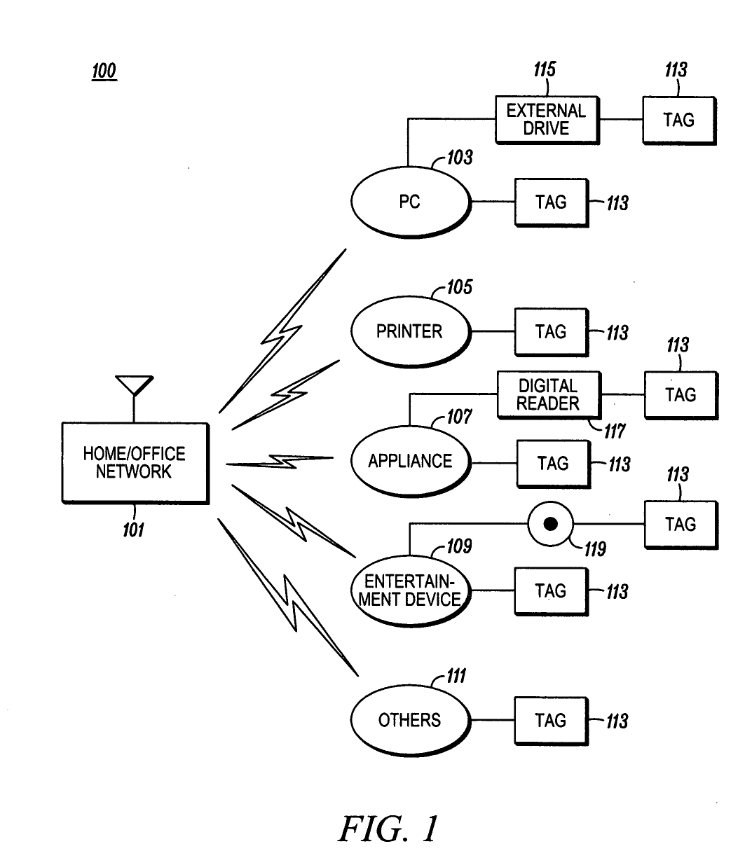

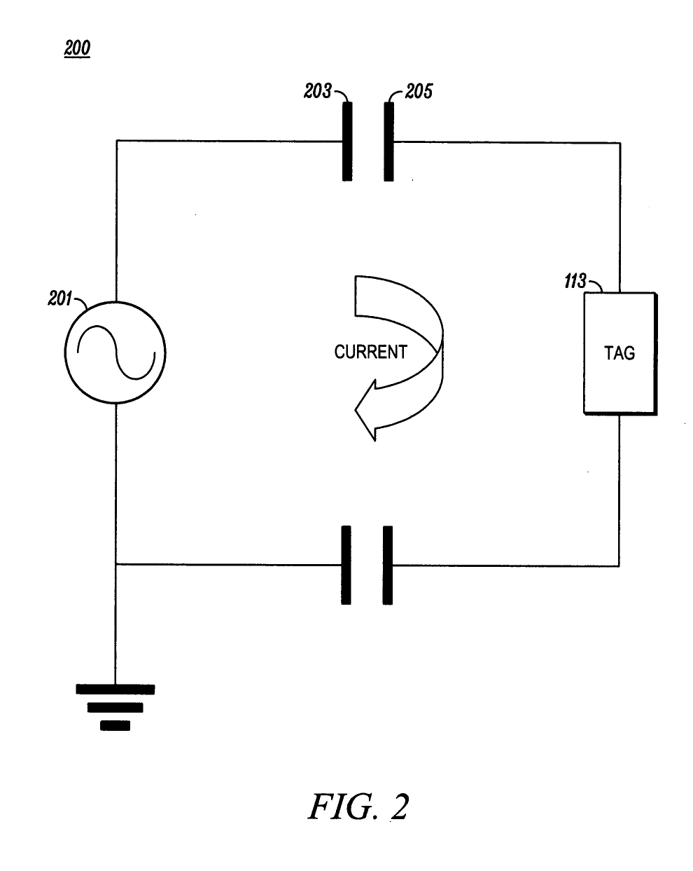

As seen in FIG. 2, a block diagram illustrates how the proximate network system 100 operates using the tag 113. Each tag is typically a passive device printed with a polymer on a flat surface such as a paper or tape adhesive. Those skilled in the art will recognize that the tag 113 is a substantially flat device that may be configured like that devised by the PolyApply consortium as discussed herein. Those skilled in the art will also recognize that other configurations having a substantially flat design with a minimal profile may also be possible in accordance with the present invention. The tag 113 is a passive device and is an electronic circuit which is energized by moving the tag 113 into proximity to an electric field 201. In operation, a reader antenna 203 coupled to the electric field 201, couples with a tag antenna 205. The proximity of the reader antenna 203 and the tag antenna 205 allows enough energy to be exchanged in order to charge and/or energize a capacitor or other device for operating a circuit on the tag 113. Since the tag 113 is a passive device, it cannot be charged unless it is in proximity to the electric field 201.

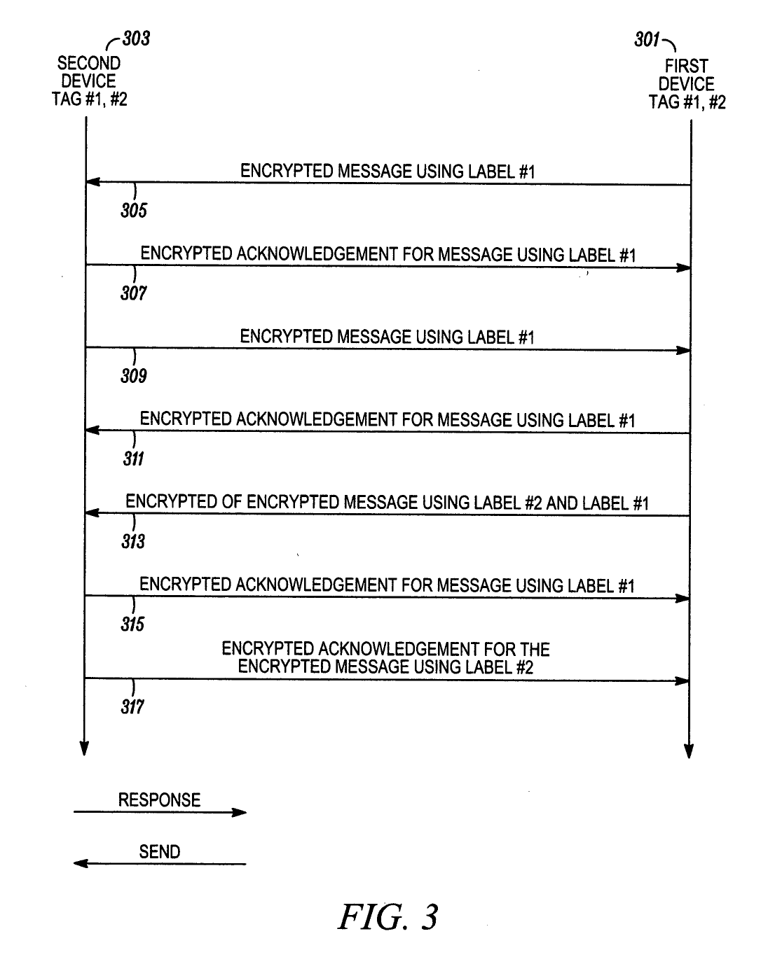

FIG. 3 is a diagram depicting an embodiment of the invention where the tags described herein are used in a method 300 for allowing device interaction for authentication or other communications within the network. A first device 301 includes both tags #1 and #2 while a second device 303 also includes tags #1 and #2. Device 301 first initiates a communication 305 to device 303 which is an encrypted message using an encryption algorithm common to tag #1. Device 303 then responds by transmitting an encrypted acknowledgment 307 back to the device 301. Similarly, the device 303 may also transmit an encrypted message 309 using an algorithm associated with tag #1 where an encrypted acknowledgment 311 is also sent from device 301 in return. Encrypted messages may also be sent using the algorithms associated with tags #1 and #2 such that only devices having both of these tags will be allowed to correctly authenticate and interpret communications between the correct devices. For example, device 301 may send an encrypted message 313 using algorithms associated with tags #1 and #2 where device 303 acknowledges receipt of the message by sending separate acknowledgment messages 315 and 317 for the messages using the same encryption algorithms. This allows only network devices having the appropriate tags to receive and encrypt messages intended for those devices. This allows devices in the network to be easy grouped or sub-grouped such that messages intended only for an intended group can be communicated without involvement of other devices outside the group.

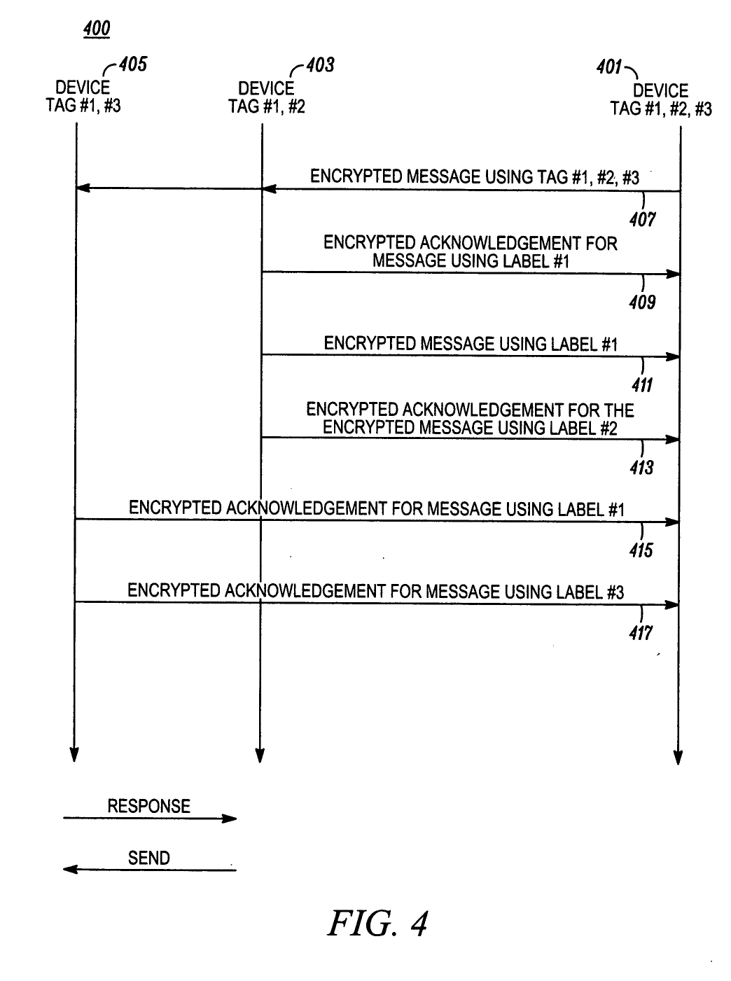

Similarly, FIG. 4 is a diagram depicting another embodiment of the invention where three (3) tags are used in combination with three (3) devices in a method 400 to allow the devices to selectively interact by exchanging encrypted communications. FIG. 4 illustrates the exchange of those network communications. As will be evident to those skilled in the art, any number of tags may be used in tandem or combination with their associated encryption algorithms to receive encrypted communications. As noted previously, these communications may be directed to groups or sub-groups of devices within the network. In this example, devices 401, 403 and 405 all represent devices operating in the network as described in FIG. 1. Device 401 transmits an encrypted message 407 using algorithms associated with tags #1, #2 and #3 to device 403 and device 405. Similarly, device 403 has affixed tags #1 and #2 while device 405 has affixed tags #1 and #3. Thus, each device having the appropriate tag and encryption algorithms may send and receive ad hoc network communications using that algorithm. This allows communications to be targeted specifically to any groups and sub-groups of devices.

Next, device 403 transmits an encrypted acknowledgment 409 for message using the algorithm associated with tag #1. Device 403 also transmits an encrypted message to device 401 using an encryption algorithm associated with tag #1. Moreover, device 403 also sends an acknowledgment message 413 for the communication it received using tag #2. Similarly, device 405 transmits an encrypted acknowledgment message to device 401 acknowledging the recognition of the message using tag #1. Device 405 also sends a separate encrypted acknowledgment message 417 to device 401 for the message using tag #3. Hence, the method 400 allows devices 401, 403 and 405 to communicate amongst themselves using encryption algorithms based on the type of tag (#1, #2, and/or #3) that are affixed to the device. Attaching tags to these devices allows each device to send and receive encrypted communications to other devices, allowing only those devices which are affixed with the appropriate tag to communicate and receive the appropriate network communications.

Thus, the invention is directed to a proximity system and method that uses a substantially flat tag or label that embodies an electronic circuit for use in authenticating a device and/or communications with other devices in a wireless network. The invention also includes an embodiment to allow media such CD (compact disc), DVD or otherwise to include identification tags so that they can be used with their associated devices. In yet another embodiment, the tag can be used to hold authentication information and encryption information or other data used in the operation of home appliances or entertainment devices to convey specific operational instructions.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A proximity detection system comprising:
a substantially flat electronic circuit printed on a label;
an electronic device used for wireless communication in a network; and
wherein the label is affixed to the electronic device for authenticating access to the network.

2. A proximity detection system as in claim 1, wherein the electronic circuit is printed on a polymer tape.

3. A proximity detection system as in claim 1, wherein the network operates using a WiFi standard.

4. A proximity detection system as in claim 1, wherein the label is energized when in direct proximity to an electric field within the electronic device.

5. A proximity detection system as in claim 1, wherein the electric field is present within the electronic device.

6. A proximity detection system as in claim 1, wherein the electronic printed circuit conveys operational data to the electronic device.

7. A proximity detection system as in claim 1, wherein an electronic device may provide encrypted communications to another electronic device based upon an encryption algorithm associated with the label affixed to the device.

8. A proximity detection system for allowing access to a wireless network comprising:
a passive electronic circuit printed onto a paper product;
an electronic device capable of operating in the wireless communications network; and
wherein the passive electronic circuit is energized by an electric field present within the electronic device.

9. A proximity detection system as in claim 8, wherein the paper product is affixed to the electronic device for authenticating access of the electronic device into the wireless communications network.

10. A proximity detection system as in claim 8, wherein the electronic circuit is printed using a polymer material.

11. A proximity detection system as in claim 8, wherein the wireless communications network operates using a WiFi standard.

12. A proximity detection system as in claim 8, wherein the paper product includes an adhesive.

13. A proximity detection system as in claim 8, wherein the passive electronic circuit includes an antenna.

14. A proximity detection system as in claim 8, wherein the passive electronic circuit also conveys operational data for the electronic device.

15. A proximity detection system as in claim 8, wherein the electronic device provides encrypted communications to other electronic devices in the system based upon the passive electronic circuit affixed to the electronic device.

16. A method for utilizing a proximity network system for authenticating access to a wireless communications network comprising the steps of:
providing a passive electronic circuit printed on a carrier;
selecting a unique carrier based upon the desired functionality of the electronic device;
affixing the carrier to an electronic device;
sending encrypted messages to the electronic device depending upon the unique carrier selection; and
authenticating access to the wireless communications network using the carrier selection.

17. A method for utilizing a proximity network system as in claim 16, wherein the carrier is an adhesive label.

18. A method for utilizing a proximity network system as in claim 16, wherein the electronic device is a home appliance.

19. A method for utilizing a proximity network system as in claim 16, wherein the wireless communications networks operate using a WiFi standard.

20. A method for utilizing a proximity network system as in claim 16, wherein the printed electronic circuit is printed using a polymer material.

21. A method for utilizing a proximity network system as in claim 16, wherein the printed electronic circuit includes an antenna.

22. A method for utilizing a proximity network system as in claim 16, wherein the step of energizing includes the step of:
moving the printed electronic circuit within the proximity of an electric field located within the electronic device.

23. A method for utilizing a proximity network system as in claim 16, further including the step of:
providing encrypted communications between electronic devices based upon the carrier affixed to the electronic device.

24. A method for utilizing a proximity network system as in claim 23, further including the step of:
organizing the electronic device into at least one group based upon the unique carrier system.

25. A proximity detection system for allowing communications in an ad hoc wireless network comprising:
an electronic device for wireless communication in the network;
at least one substantially flat label affixed to the electronic device that is imprinted with an electronic circuit; and
wherein the electronic circuit is associated with an encryption algorithm for providing encrypted communications using that algorithm.

26. A proximity detection system for allowing communications in an ad hoc wireless network as in claim 25, wherein the electronic device is affixed with a plurality of labels for receiving at least one encrypted communication associated with grouped devices.

27. A proximity detection system for allowing communication in an ad hoc wireless network as in claim 25, wherein the electronic circuit is printed on a polymer tape.

28. A proximity detection system for allowing communications in an ad hoc wireless network as in claim 25, wherein the label is energized when in direct proximity to an electric field.
